(19) United States
(12) Patent Application Publication
(10) Pub. No.: US 2004/0163455 A1
(43) Pub. Date: Aug. 26, 2004

(54) Tire testing machine and process

(75) Inventor: Denis Deniau, Blanzat (FR)

Correspondence Address: FITZPATRICK CELLA HARPER & SCINTO, 30 ROCKEFELLER PLAZA, NEW YORK, NY, 10112, US

(73) Assignee: Michelin Recherche et Technique, S.A.

(21) Appl. No.: 10/783,470

(22) Filed: Feb. 20, 2004

Related U.S. Application Data
(63) Continuation of application No. PCT/EP02/08829, filed on Aug. 7, 2002.

(30) Foreign Application Priority Data
Aug. 21, 2001 (FR) 01/10975

(51) Int. Cl. G01M 17/02

(52) U.S. Cl. 73/146

(57) ABSTRACT

To measure a tire and check that its characteristics conform with those expected, a unique machine is provided which can take into account the parameters corresponding to a test carried out with or without load, whether at rest or in rotation, and whether static or dynamic. It is shown that by choosing to mount the tire vertically in the machine with its rotation axis horizontal, all the calibration problems of machines of the prior art are resolved. In particular, a roller (22) in contact with the tire is provided with piezoelectric cells (Y, Z) which measure applied forces, while in addition the machine itself rests on pads (17-18) provided with piezoelectric cells to measure the forces it supports.

### BACKGROUND OF THE INVENTION

The object of the present invention is a tire testing machine and process. Its purpose is to record in a more exact way the measured characteristics of tires, also known as bare tires.

A tire testing machine is known in particular from the document U.S. Pat. No. 6,016,695. In this machine, tires are brought up, uninflated, to a measuring device by means of a conveyor belt. On arrival in the device, two flanges are applied to the sidewalls of the tire and the tire is inflated under conditions corresponding to its use. The geometrical characteristics of the tire are then measured. In particular, these geometrical characteristics are measured after the tire has been set in motion by a motor which drives one of the flanges, while the other rotates freely. The geometrical characteristics are measured under load. The load is applied to the tire by bringing against it a roller or loadwheel.

For measurement purposes, various types of sensors are positioned close to the periphery of the tire to feel the surface of the tire and deduce its geometrical characeristics. To allow for the various types of tires to be measured, the feelers themselves can be displaced so as to approach the surface of the tire to be measured more closely or less so. Several faults arise from this method.

Firstly, the machine cannot be used to measure at the same time the geometrical characteristics of the tire and its other characteristics as follows: static imbalance and dynamic imbalance. Secondly, the calibration of the measurement systems does not extend to full scale, and the measurement hysteresis is not taken into account.

In the invention these problems have been solved by noting that all the said faults were due to the measurement method. In effect, the tires are always transported uninflated for practical reasons. Under these conditions the measurements are also made while uninflated.

### SUMMARY OF THE INVENTION

By choosing according to the invention to present the tire vertically, the measurements of the tire's static deformation correspond to the true deformations, namely those undergone by tires when they are in use. In the invention, the machine measures under load the radial and lateral reactions of the tires as well as the vertical reactions. It therefore proved possible to rest the machine or part of it on weighing devices, in particular high-precision piezo-electric weighing devices and by measuring the signal emitted by these weighing devices to note oscillations of the machine itself or parts of it. These oscillations are images of the behavior modifications caused by faults in the tires to be measured.

Since the machine rests on weighing devices it suffices to calibrate it once and for all (or if necessary at regular intervals, for example once a year owing to for drift) by exerting calibrated forces on the machine in specified directions and measuring the signals emitted in response by the weighing devices. This provides a simple general transducer. Finally the measurements are also dynamic measurements, in which the characteristics of the tire affect the measurement but do not affect the calibration of the machine.

As an improvement to increase the sensitivity of the machine it is provided on the one hand that the tires to be measured are rotated at a speed higher than that normally used in the state of the art. For example, the speed of sixty revolutions per minute traditionally used becomes a speed of 150 revolutions per minute. Similarly, rather than inflating the tire to a nominal inflation pressure that corresponds to its actual use, it is preferred to magnify the tire's faults in order to make them easier to measure. To that end the inflation pressure during the test is increased, namely by raising it for example to four bars.

Besides, the fact that the tire is held vertically between two vertical flanges allows each of the flanges to be driven by a motor. In order not to generate torsional forces in a tire, the speeds and positions of the two motors are adjusted so that the two tire flanges are driven in an identical way and not as in the present state of the art, in which one side of a tire driven by a flange carries along the other, freely rotating flange through broaching by friction.

The object of the invention is therefore a machine for tire testing, which comprises means for holding the tire and means for measuring characteristics of the tire held, characterized in that the measuring means comprise sensors positioned in a base upon which the machine rests on the ground.

A further object of the invention is a process for testing a tire in a machine comprising means for holding the said tire and means for measuring characteristics of the tire held, characterized in that the measuring device is located in a base upon which the machine rests on the ground.

### BRIEF DESCRIPTION OF THE DRAWINGS

The invention will be better understood on reading the description below and examining the figures that go with it. These are presented only as an indication and in no way constitute a limitation of the invention. The figures show:

FIG. 1: Front view of the tire testing machine according to the invention

FIG. 2: Side view of the machine shown in FIG. 1

FIG. 3: View from above of the same machine

### DETAILED DESCRIPTION OF THE INVENTION

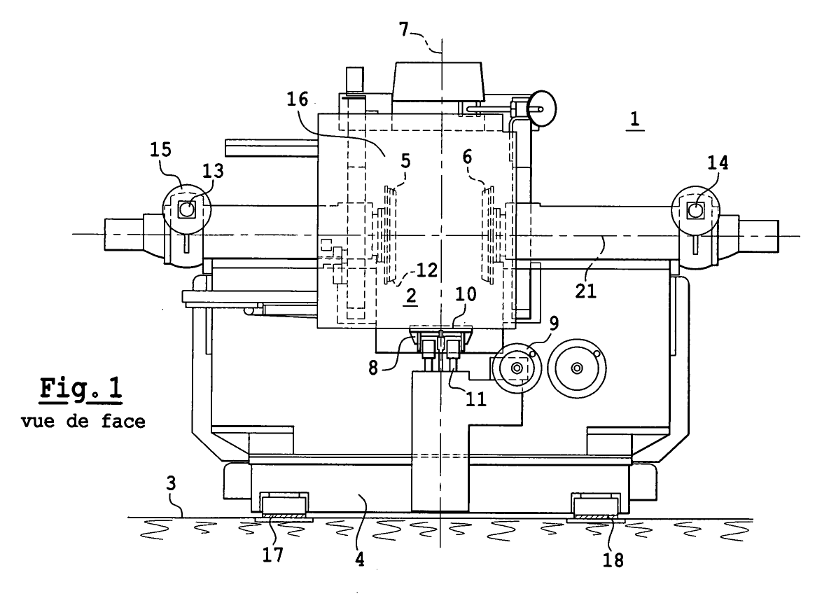

In accordance with the invention FIG. 1 shows a tire testing machine 1. A tire (not shown) is intended to be placed in a holding device 2 of the machine 1, facing the means for measuring the characteristics of the tire so held. The means for measuring the characteristics will be described later. The device 2 for holding the tire according to the invention is characterized in that it enables the tire to be held vertically in the machine. Indeed, the machine 1 rests on the ground 3 via a base 4. To hold a tire, the holding device 2 comprises two vertical flanges 5 and 6, respectively on the left and right, designed to be brought in towards the two respective sides of the vertical tire presented, preferably symmetrically relative to a vertical symmetry plane 7 of the machine. ‘Vertical’ means that the tire is presented in the machine in a position which corresponds to its normal use for a vehicle rolling on a road. In practice, the tire is presented at an appropriate height by means of a centering device 8 which is in this case manipulated and adjusted, for example, using a crank handle 9. For this purpose the centering device comprises a plate 10 supported on feet 11 manipulated by the crank handle 9. It is preferable for the centering device 8 to have means, for example a tilting plate, whereby the tire is ejected by rolling off on its tread once the measurement has been carried out.

The centering flanges 5 and 6 preferably have chamfered shims such as 12, designed to move laterally into the two circular openings on either side of the tire so as to center it automatically. The centering device 8 is designed to approach the tire with a tolerance corresponding to the relief of the chamfers. In practice the crank handle 9 can be associated with an index which, for a given type of tire, enables the tire that is to be measured to be pre-positioned in advance so that it will be in the correct position relative to the flanges 5 and 6.

When the tire is in place, the flanges 5 and 6 are moved horizontally and symmetrically towards one another, perpendicularly to the plane 7, to take their place. When they are in position the tire is inflated, for example by blowing air in through a wall of one of the flanges. In one example, as indicated above, the inflation pressure is higher than a nominal pressure at which the tire would be used. For the measurements it would typically be four bars, or about twice as high, for example plus or minus 15%, as a nominal utilization pressure. The flanges 5 and 6 are also driven by motors 13 and 14 respectively. Preferably, the two motors 13 and 14 are tuned to one another in speed and angular position such that neither can exert a twisting force on the tire, which would falsify the measurements. In this way the two flanges form half-wheels of a common wheel.

Moreover, the motors 13 and 14 are provided with indexing devices 15 which enable the rotary position of the flanges to be known at any instant. Thus, during measurements, such devices 15 make it possible to note the angular coordinate of the tire at which parameter values are measured. For a given parameter this indexing allows its evolution to be plotted as a function of this angle. Since the tire is set in motion by the motors 13 and 14, and to protect the operator against any risk of projection, the tires and the flanges are positioned behind a strong protective screen 16. For that reason the components shown in FIG. 1 which are masked by the screen 16 are drawn using broken lines.

The base 4 essentially comprises a range of weighing devices such as 17 and 18. The weighing devices 17 and 18 comprise high-precision, high-dynamics piezoelectric sensors. The piezoelectric sensors are sensors which emit an electrical signal whose intensity, voltage or frequency depends on a mechanical force acting on them. Besides supporting the machine 1 they also provide an instantaneous measurement of the micro-displacements of the base 4. In one example, two weighing devices are installed. These two weighing devices 17 and 18 are located symmetrically with respect to the plane 7. A non-dynamometric pad (but one which could also comprise a third weighing device), which is not shown in FIG. 1, is located in a plane further away from the viewer than the plane of the weighing devices 17 and 18. It can be shown that rocking movements of the machine 1 from right to left and reciprocally from left to right produce signals emitted by the weighing devices 17 and 18 with variations in opposite directions. In contrast, rocking movements forwards and backwards and vice-versa produce signals emitted by the weighing devices 17 and 18 which are in the same direction. By manipulating the addition or subtraction of the signals from the weighing devices 17 and 18, all the measurements sought are obtained. If necessary more weighing devices can be used, but the minimum number is two in order to measure rocking movements from left to right and ones forwards and backwards. In particular the said weighing devices enable the dynamic characteristics of bare tires to be measured.

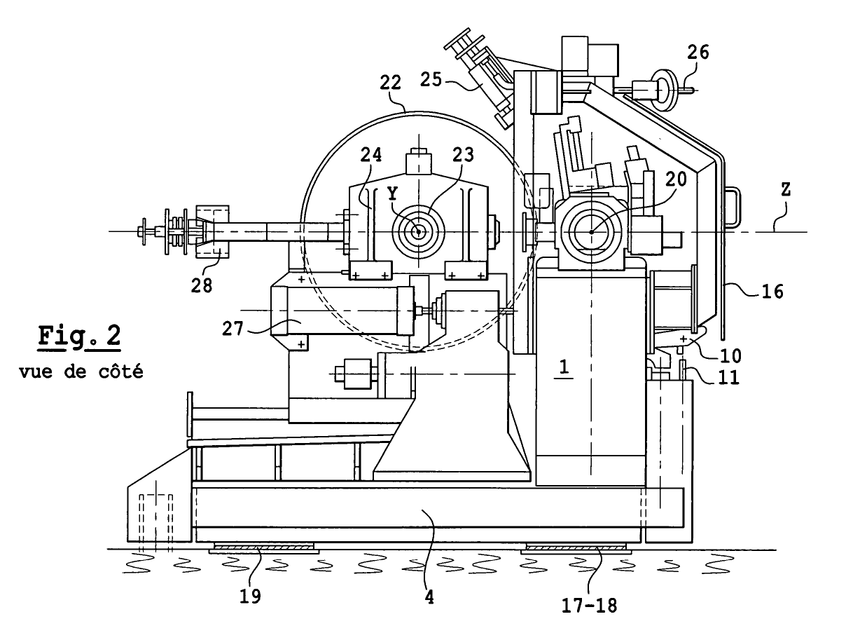

FIG. 2 is a side view showing the rear pad 19, which is located to the rear relative to the forward weighing devices 17 and 18. Overall, FIG. 2 is presented as a cross-section along the plane 7 and comprises the point 20 representing the rotation axis 21 (FIG. 1) of the flanges 5 and 6. The figure also shows that the support 10 is designed to push the tire to be measured in the direction of a roller 22 which allows the rolling of the tire to be simulated. The roller 22 is basically held by a bearing 23 held firmly by consoles such as 24 in the machine 1. In this case the roller 22 is a convex roller.

Moreover, in a known way, the machine 1 is provided with the various measuring elements that constitute the measuring device. Thus, it will comprise an out-of-roundness sensor 25. In particular this sensor 25 can be brought near the tread of the tire by means of a crank handle such as 26. The principle of such a sensor consists in applying an elastic element, for example a rod, against the surface of a tire to be measured, with a certain bending force. A sensor is positioned in the flexible part of the rod, in particular a stress gauge, and the variation of the bending of the rod is measured. From this the displacement in space of the surface of the tire against which the rod is pressing can be deduced. Thus, the out-of-roundness measurement consists in measuring the deviation of the tire from roundness, namely the extent, if any, to which it is oval. The same type of sensor can be used to measure a sidewall deformation. In this case the end of the rod rests against a sidewall of the tire. It is preferable to use simultaneously one out-of-roundness sensor FR and two sidewall deformation sensors DF to measure the deformations of both sides of the tire. Preferably, these out-of-roundness FR and sidewall deformation DF measurements are made not under load, i.e. when the roller 22 is not pressing against the tire.

When the tire is pressed against the roller, the rigidity of the tire is measured. The purpose of measuring the rigidity is to measure that during the fabrication of the tire, the various elastomeric layers and reinforcement plies constituting the tire have been arranged and distributed regularly, in accordance with the manufacturing specifications, all around the periphery of the tire. In particular, the rigidity is measured as a function of the indexed angle of the tire's angular position. The effect of rigidity is reflected by a reaction exerted by the tire against the roller 22, in particular its bearing 23. For a static measurement the bearing 23 comprises different sets of sensors. The sensors are arranged in it so as to de-couple the forces in a direction Z (load direction) orientated along a radius of the roller 22, in the example as illustrated essentially a horizontal direction, and a direction Y perpendicular to the line Z, measured in the axis of the bearing 23.

For this purpose the consoles 24 are subjected to a force corresponding to a nominal load by means of a pressure device 27. When, owing to its rotation, there is a decrease of rigidity at the location of the contact area of the tire against the roller 22, the console 24 and therefore the sensor at Z, itself also preferably a piezoelectric gauge, undergo a micro-displacement, here towards the right of FIG. 2. In contrast, if there is an increase of rigidity the roller 22 is pushed back and the signal measured by the sensor Z changes sign.

In measuring the characteristics of the tire during rolling, preferably under load, the essential aim is to determine deviations during free rolling, without measuring the rolling resistance. The deviation due to free rolling (made necessary in certain cases for reasons relating to the transverse slope of the roads on which vehicles circulate) has the overall effect of pushing the roller 22 towards a plane further away from the viewer than that shown in FIG. 2, or on the contrary, bringing it closer to the viewer of the figure. Finally, in the measurement bar associated with the bearing 23 a sensor is provided at Y, preferably again a piezoelectric sensor, which measures the displacement of the roller 22 perpendicularly to its plane.

The fact that the sensors are so arranged on the spindle and in the bearing 23 of the roller 22 makes it possible not to have any correspondence between the position of the said sensors and the type of tire to be measured. Indeed, only the mechanism 27 has to take into account the type of tire to be measured. It moves further or less far depending on the diameter of the tire, and its contact pressure can be different depending on the utilization force to be exerted. In contrast, the built-in nature of the sensors incorporated in the roller 22 makes them independent of the size of the tire.

Furthermore, in a particularly advantageous way, for calibration purposes it is possible while bearing on the machine 1 to try to displace the roller relative to its support. To that end, a calibration device 28 (mobile) is provided to impose a load upon the roller 22 for the purpose of calibrating the sensor at 2. With a calibrated force or displacement applied by the device 28 to the consoles 24, the corresponding signal emitted by the sensor Z described is measured. A calibration table can then be worked out particularly simply. The same operation can of course be carried out for the sensor Y. Similarly, the same type of calibration can be carried out for the weighing devices 17 and 18, but this time by exerting forces on the machine as a whole.

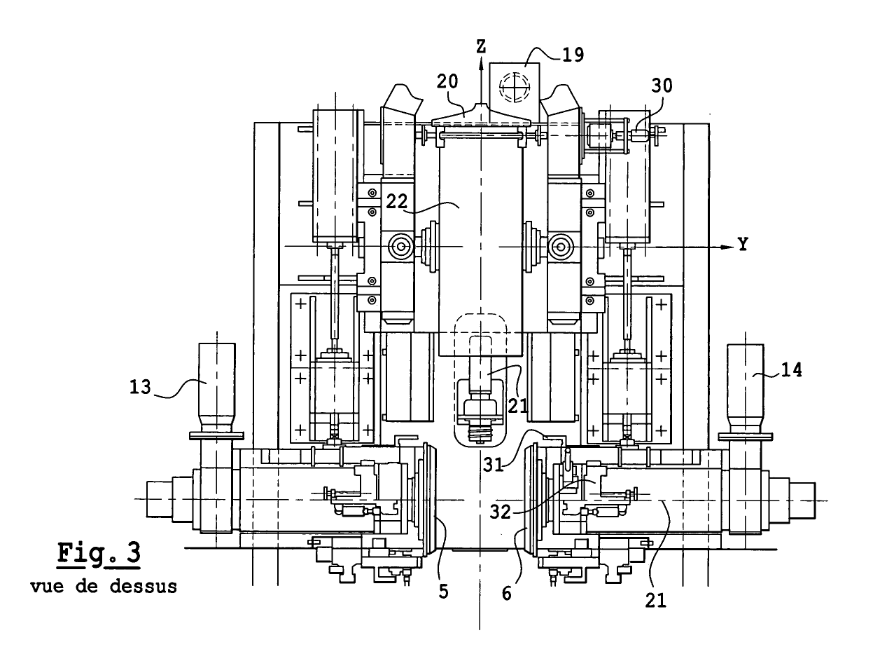

For this purpose FIG. 3 shows, as seen from above, a rocking mechanism 29 that can be used to calibrate the sensors Y and Z. Of course, this mechanism has to be taken off the roller 22 after the calibration. The rocking mechanism 29 is designed to be pulled in the direction Y into position, or with a given force, by a pulling device 30 (which can also be taken off after the calibration).

FIG. 3 also shows the motors 13 and 14 connected to the half-shafts which drive the flanges 5 and 6 via reduction gears. The motors 13 and 14 are tuned to one another by a control device. Release tabs 31 and feelers 32 to detect the presence of the tire are also mounted on the half-shafts. The tabs 31 serve to release the tire from the flanges 5 and 6 once the measurement has been made.

It will be noted that the fact that the roller 22 is kept in the load position against the tire to be measured means that the measurements are made under load, at constant deflected radius, while in practice the load deflects the tire. The deflected radius is the radius of the tire at the point where the load deflects it. The deflected radius is smaller than the nominal radius. In fact, the real phenomenon undergone by a tire is that a load increase produces a still smaller deflected radius. In the invention, the fact that the sensors Y and Z are placed in the bearing 23 means that a variable load, or rigidity, is being measured constant deflected radius. It could easily be shown that the function obtained is the reciprocal of the function desired, and that the measurements so made are significant. In contrast, the fact that the characteristics of the tire are measured at constant deformed radius is much more favorable to the precision and fidelity of the measurements made with the machine.

All the measurements envisaged so far are made on a rotating tire. However, the special feature of the machine of the invention is that particularly by virtue of the weighing devices 17 and 18 or the sensors at Y and Z, it allows dynamic measurements to be made with the same machine for the same, single positioning of the tire in the machine, in particular measurements of the static or dynamic imbalances. So the same machine is used for measurements of both kinds, whereas in the prior art there would have to be a second machine.

Owing to the positions of the sensors in the bearing 23 or of the weighing devices 17 and 18, measurement problems can arise. To solve these problems the machine is calibrated taking into account a hysteresis that results from the machine's structure. To that end, the responses of the sensors are measured for a first, given direction of a force applied in one direction, Y or Z, and then for the opposite sense of the same direction. The machine can then be correctly calibrated, allowing for its response as a function of the direction of the force measured. For this purpose, for each parameter measured, in practice for each sensor, a table is prepared giving the correspondence of the algebraic value of a force (taking its sign into account) and the corresponding signal emitted by the sensor.

In the same way that the machine 1 led to the use of piezoelectric sensors, and since the machine's precision was increased thereby, it proved possible to try to make dynamic measurements with a tire speed higher than the nominal utilization speed (for example, two-and-a-half times the latter), and also with a higher inflation pressure (for example, about twice as large) than the nominal pressure. The shapes and reactions of the unloaded and loaded tires proved much easier to measure. These increases of speed and pressure finally increase the sensitivity of the machine.

What is claimed is:

1. A tire testing machine, comprising a device for holding the tire and a means for measuring the characteristics of the tire held, wherein the measuring means comprises sensors positioned in a base upon which the machine rests on the ground.

2. The machine according to claim 1, further comprising a reaction roller which presses against the tire, and a means for bringing the tire in contact with the roller, wherein the sensors are in the roller, and wherein the sensors measure the characteristics of the tire in contact with the roller.

3. The machine according to claim 2, wherein the roller is convex.

4. The machine according to claim 2, wherein the sensors are sensors of forces (Y, Z) experienced by the roller at constant position.

5. The machine according to claim 1, wherein the tire holding device holds the tire vertically in the machine.

6. The machine according to claim 1, wherein the sensors are piezoelectric sensors.

7. The machine according to claim 1, further comprising means for driving the tire in rotation at about 150 revolutions per minute.

8. The machine according to claim 7, wherein the means for driving the tire in rotation comprise two flanges positioned in contact with either side of the tire motors which drive each of the said flanges in rotation, and a device for tuning the motors to one another.

9. The machine according to claim 1, wherein the sensors are selected from the group consisting of out-of-roundness sensors, lateral deformation sensors, and combinations thereof.

10. The machine according to claim 1, wherein the measuring device comprises a device for measuring the rotational position of the tire in the machine.

11. A process for testing a tire, wherein the tire is placed in a machine comprising a device for holding the tire and a device for measuring the characteristics of the tire held, wherein the measuring device is located in a base upon which the machine rests on the ground.

12. The process according to claim 11, wherein:
a reaction roller is pressed against the tire,
the tire is driven in rotation while in contact with the roller, and
sensors incorporated in the roller are used to measure the characteristics of the rotating tire.

13. The process according to claim 12, wherein the tire is rotated at approximately 150 revolutions per minute.

14. The process according to claim 12, wherein the sensors are located in a bearing of the roller.

15. The process according to claim 11, wherein:
the tire is driven in rotation by two flanges pressed on either side of the tire
and by motors which drive in rotation each of the said flanges, and in that the speeds and/or positions of the two motors are tuned to one another.

16. The process according to claim 11, wherein the tire is held vertically in the machine at the time of measurement.

17. The process according to claim 11, wherein the measuring device is calibrated, at rest, by applying calibrated forces to the machine and measuring the corresponding signals emitted by the sensors.

18. The process according to claim 17, wherein a hysteresis of the measuring device is determined.

19. The process according to claim 11, wherein the tires are inflated to 4 bars.
